(19) United States
(12) Patent Application Publication
(10) Pub. No.: US 2012/0131565 A1
(43) Pub. Date: May 24, 2012

(54) SYSTEM AND METHOD FOR UPDATING FIRMWARE OF BASEBOARD MANAGEMENT CONTROLLER OF COMPUTING DEVICE

(75) Inventor: YU-GANG ZHANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/975,260

(22) Filed: Dec. 21, 2010

(30) Foreign Application Priority Data
Nov. 18, 2010 (CN) 201010549617.0

(51) Int. Cl. G06F 9/44

(52) U.S. Cl. 717/168

(57) ABSTRACT

A method and system for updating a firmware of a baseboard management controller (BMC) of a computing device. The method acquires configuration information of the BMC from a bus controller of the computing device, queries an address of the BMC on a local bus of the computing device according to the configuration information, and acquires firmware storage information of a firmware memory of the BMC through the local bus according the queried address. The method allocates a virtual storage space for the firmware in a memory space of a processor of the computing device, and maps a storage space for storing the firmware of the firmware memory to the virtual storage space. The method updates the firmware of the BMC by writing firmware data of the BMC to the virtual storage space.

### BACKGROUND

1. Technical Field

Embodiments of the present disclosure relate generally to data updating technology, and more particularly, to a system and method for updating a firmware of a baseboard management controller (BMC) of a computing device.

2. Description of Related Art

A baseboard management controller (BMC) is a specialized service processor that monitors a physical state of a computer, server or other hardware devices. The BMC is usually contained in a motherboard or main circuit board of the device to be monitored. A firmware of the BMC may be updated during the process of designing and maintaining of the BMC. One typical firmware updating method uses a firmware updating tool to update the firmware of the BMC. However, the firmware updating tool needs to work with a software program of the BMC to update the firmware, which causes the firmware to not update when the software program has crashed or been damaged. Additionally, the software program occupies part of processor resources of the BMC causing the update speed of the firmware to be very slow.

### BRIEF DESCRIPTION OF THE DRAWINGS

FIG. 1 is a block diagram of one embodiment of a computing device including an updating system.

FIG. 2 is a block diagram of one embodiment of functional modules of the updating system of FIG. 1.

FIG. 3 is a flowchart of one embodiment of a method for updating a firmware of a baseboard management controller of the computing device of FIG. 1.

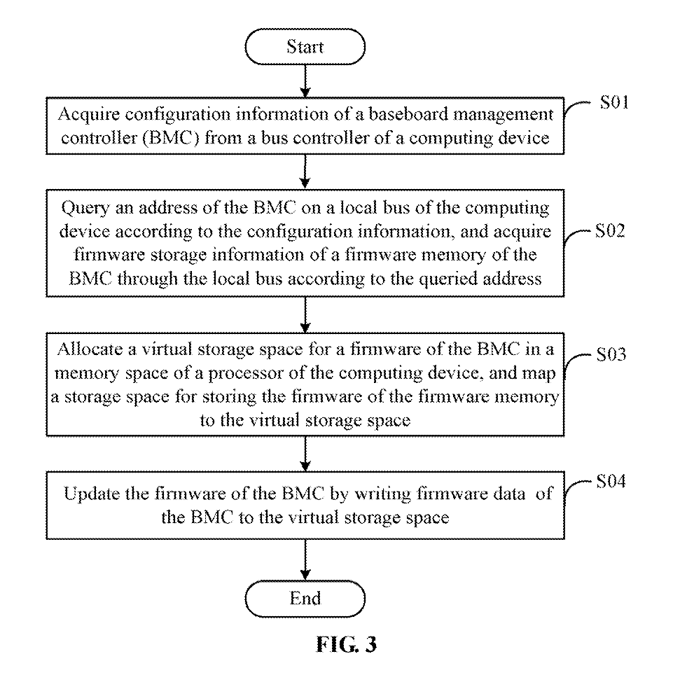

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

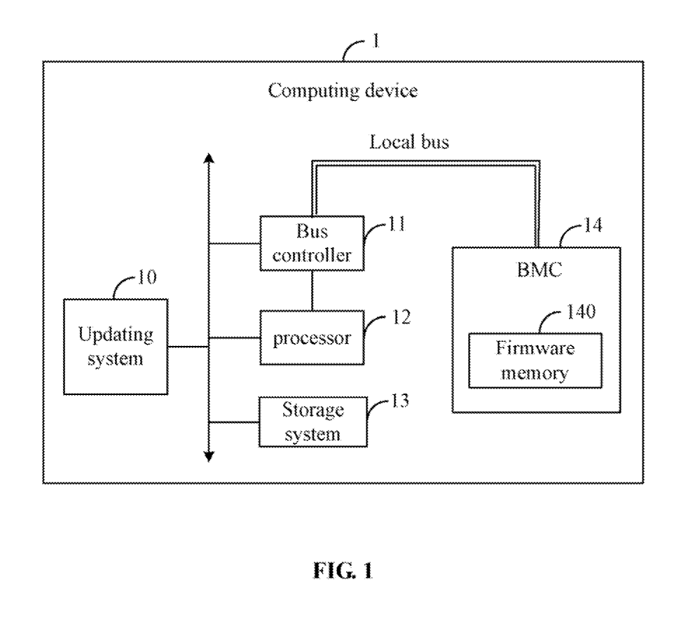

FIG. 1 is a block diagram of one embodiment of a computing device 1 including an updating system 10. In the embodiment, the computing device 1 further includes a bus controller 11, a processor 12, a storage system 13, and a baseboard management controller (BMC) 14. The bus controller 11 is electronically connected with the BMC 14 through a local bus. The local bus may be a peripheral component interconnect (PCI) bus or a peripheral component interconnect express (PCIE) bus. The processor 12 may control the BMC 14 through the bus controller 11. The BMC 14 includes a firmware memory 140 to store a firmware of the BMC 14. In one embodiment, the computing device 1 may be a computer, a server, or other hardware device. The firmware memory 140 may be, for example, a flash memory, a programmable read-only memory (PROM), or an electronically erasable programmable read-only memory (EEPROM). It should be apparent that FIG. 1 is only one example of the computing device 1 that can be included with more or fewer components than shown in other embodiments, or a different configuration of the various components.

The storage system 13 stores one or more programs, such as programs of an operating system, and other applications of the computing device 1. In one embodiment, the storage system 13 may be random access memory (RAM) for temporary storage of information, and/or a read only memory (ROM) for permanent storage of information. In other embodiments, the storage system 13 may also be an external storage device, such as a hard disk, a storage card, or a data storage medium. The processor 12 executes computerized operations of the computing device 1 and other applications, to provide functions of the computing device 1.

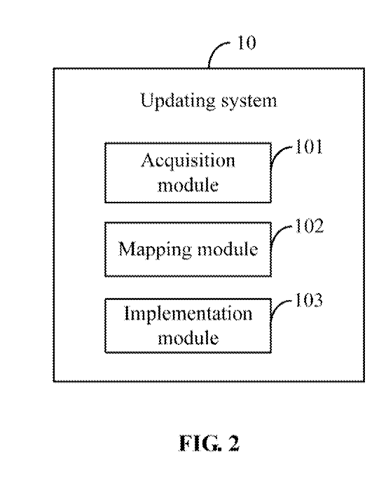

FIG. 2 is a block diagram of one embodiment of functional modules of the updating system 10. The updating system 10 may include a plurality of functional modules comprising one or more computerized instructions that are stored in the storage system 13 or a computer-readable medium of the computing device 1, and executed by the processor 12 to perform operations of the computing device 1. In one embodiment, the updating system 10 includes an acquisition module 101, a mapping module 102, and an implementation module 103. In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of computer-readable medium or other storage device.

The acquisition module 101 is operable to acquire configuration information of the BMC 14 from the bus controller 11. In one embodiment, the configuration information includes a device identity (i.e., the device ID) and a vender identity (i.e., the vender ID) of the BMC 14. When the BMC 14 is installed on the computing device 1 through the local bus, the bus controller 11 may allocate a small storage space (e.g., 256 bytes) for storing the configuration information of the BMC 14. In the embodiment, the acquisition module 101 may acquire the configuration information from the bus controller 11 through the operating system of the computing device 1.

The acquisition module 101 is further operable to query an address of the BMC 14 on the local bus according to the configuration information, and acquire firmware storage information of the firmware memory 140 of the BMC 14 through the local bus according the queried address. In one embodiment, the firmware storage information includes a range of storage capacity of a storage space for storing the firmware of the BMC 14 and an address of the storage space in the firmware memory 140.

The mapping module 102 is operable to allocate a virtual storage space for the firmware of the BMC 14 in a memory space of the processor 12, and map a storage space for storing the firmware of the firmware memory 140 to the virtual storage space. In one embodiment, the memory space of the processor 12 may be a range of storage space of a memory of the computing device 1 allocated for the processor 12.

The implementation module 103 is operable to update the firmware of the BMC 14 by writing firmware data of the BMC 14 to the virtual storage space. In one embodiment, the firmware data is to be updated, and may be prestored in the storage system 13.

FIG. is a flowchart of one embodiment of a method for updating a firmware of BMC 14 of the computing device 1 of FIG. 1. The method can update the firmware of the BMC 14. Depending on the embodiment, additional blocks may be added, others removed, and the ordering of the blocks, may be changed.

In block S01, the acquisition module 101 acquires configuration information of the BMC 14 through the bus controller 11. In one embodiment, the configuration information includes a device identity (i.e., the device ID) and a vender identity (i.e., the vender ID) of the BMC 14. The details of acquiring the configuration information are provided above.

In block S02, the acquisition module 101 queries an address of the BMC 14 on the local bus according to the configuration information, and acquires firmware storage information of the firmware memory 140 of the BMC 14 through the local bus according the queried address. In one embodiment, the firmware storage information includes a range of storage capacity of a storage space for storing the firmware and an address of the storage space in the firmware memory 140. The local bus may be a Peripheral component Interconnect (PCI) bus or a Peripheral component Interconnect Express (PCIE) bus.

In block S03, the mapping module 102 allocates a virtual storage space for the firmware of the BMC 14 in a memory space of the processor 12, and maps a storage space for storing the firmware of the firmware memory 140 to the virtual storage space. In one embodiment, the memory space of the processor 12 may be a range of storage space of a memory of the computing device 1 allocated for the processor 12.

In block S4, the implementation module 103 updates the firmware of the BMC 14 by writing firmware data of the BMC 14 to the virtual storage space. In one embodiment, the firmware data is to be updated, and may be prestored in the storage system 13.

In the disclosure, the updating system 10 uses a virtual memory technology to allocate the virtual storage space for the firmware in the memory space of the processor 12, and map the storage space for storing the firmware of the firmware memory 140 to the virtual storage space. Thereupon, the firmware data of the BMC 14 may be written to the firmware memory 140 by writing the firmware data to the virtual storage space. Despite software programs of the BMC 14 is crashed or damaged, the firmware of the BMC 14 may be also updated.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for updating a firmware of a baseboard management controller (BMC) of a computing device, the method comprising:
acquiring configuration information of the BMC from a bus controller of the computing device;
querying an address of the BMC on a local bus of the computing device according to the configuration information;
acquiring firmware storage information of a firmware memory of the BMC through the local bus according to the queried address;
allocating a virtual storage space for the firmware of the BMC in a memory space of a processor of the computing device according to the firmware storage information;
mapping a storage space for storing the firmware of the firmware memory to the virtual storage space; and
updating the firmware of the BMC by writing firmware data of the BMC to the virtual storage space.

2. The method according to claim 1, wherein the configuration information is acquired from the bus controller through an operating system of the computing device.

3. The method according to claim 1, wherein the configuration information include a device identity of the BMC and a vender identity of the BMC.

4. The method according to claim 1, wherein the firmware storage information include a range of storage capacity of the storage space for storing the firmware and an address of the storage space in the firmware memory of the BMC.

5. The method according to claim 7, wherein the local bus may be a peripheral component interconnect bus or a peripheral component interconnect express bus.

6. The method according to claim 1, wherein the firmware data of the BMC is prestored in a storage system of the computing device.

7. A computing device, comprising:
a baseboard management controller (BMC);
at least one processor;
a storage system; and
one or more programs stored in the storage system and being executable by the at least one processor, the one or more programs comprising:
an acquisition module operable to acquire configuration information of the BMC from a bus controller of the computing device, query an address of the BMC on a local bus of the computing device according to the configuration information, and acquire firmware storage information of a firm memory of the BMC through the local bus according the queried address;
a mapping module operable to allocate a virtual storage space for the firmware of the BMC in a memory space of the at least one processor according to the firmware storage information, and map a storage space for storing the firmware of the firmware memory to the virtual storage space; and
an implementation module operable to update the firmware of the BMC by writing firmware data of the BMC to the virtual storage space.

8. The computing device according to claim 7, wherein acquisition module acquires the configuration information from the bus controller through an operating system of the computing device.

9. The computing device according to claim 7, wherein the configuration information include a device identity of the BMC and a vender identity of the BMC.

10. The computing device according to claim 7, wherein the firmware storage information includes a range of storage capacity of the storage space for storing the firmware and an address of the storage space in the firmware memory of the BMC.

11. The computing device according to claim 7, wherein the local bus may be a peripheral component interconnect bus or a peripheral component interconnect express bus.

12. The computing device according to claim 7, wherein the firmware data is prestored in a storage system of the computing device.

13. A storage medium storing a set of instructions, the set of instructions capable of being executed by a processor of a computer to perform a method for updating a firmware of a baseboard management controller (BMC) of a computing device, the method comprising:
acquiring configuration information of the BMC from a bus controller of the computing device;
querying an address of the BMC on a local bus of the computing device according to the configuration information;
acquiring firmware storage information of a firmware memory of the BMC through the local bus according to the queried address;
allocating a virtual storage space for the firmware of the BMC in a memory space of a processor of the computing device according to the firmware storage information;
mapping a storage space for storing the firmware of the firmware memory to the virtual storage space; and
updating the firmware of the BMC by writing firmware data of the BMC to the virtual storage space.

14. The storage medium as claimed in claim 13, wherein the configuration information is acquired from the bus controller through an operating system of the computing device.

15. The storage medium as claimed in claim 13, wherein the configuration information includes a device identity of the BMC and a vender identity of the BMC.

16. The storage medium as claimed in claim 13, wherein the firmware storage information includes a range of storage capacity of the storage space for storing the firmware and an address of the storage space in the firmware memory of the BMC.

17. The storage medium as claimed in claim 13, wherein the local bus may be a peripheral component interconnect bus or a peripheral component interconnect express bus.

18. The storage medium as claimed in claim 13, wherein the firmware data is prestored in a storage system of the computing device.
